(19) United States
(12) Patent Application Publication
(10) Pub. No.: US 2013/0339846 A1
(43) Pub. Date: Dec. 19, 2013

(54) MULTIPARTY DOCUMENT GENERATION AND MANAGEMENT

(71) Applicant: James Buscemi, Camarillo, CA (US)

(72) Inventor: James Buscemi, Camarillo, CA (US)

(73) Assignee: GBL SYSTEMS CORPORATION, Camarillo, CA (US)

(21) Appl. No.: 13/526,349

(22) Filed: Jun. 18, 2012

(51) Int. Cl. G06F 17/00; G06F 17/21

(52) U.S. Cl. 715/254; 715/273

(57) ABSTRACT

An embodiment of a multiparty document generation and management system includes a document server having a user interface module, a model module, a governance module, a query module, and a suggestion module. The system allows a plurality of users to generate a document model comprising a plurality of document elements and provides suggestions to the plurality of users regarding the document model structure. The system obtains standard language for each document element in the document model and generates a complete multiparty document. Upon validation of the complete multiparty document, the multiparty document and the document model and are stored in a data storage area. Once a document model has been created, the document model can be analyzed and traversed in response to a query to provide a forecast that includes an expected result of an application of the multiparty document to the subject matter of the query.

### BACKGROUND

1. Field of the Invention

The present invention generally relates to document modeling and management of complicated multiparty agreements and more particularly relates to the creation, implementation and management of complex legal trusts.

2. Related Art

Conventional document management systems and legal contract management systems are challenged by the inexact nature of language and the meaning of such language. Some conventional systems have attempted to solve these challenges by using an informal schematic notation that is used to summarize the structure of agreements in a legal document as a collection of interrelated obligations. For example, in Daskalopulu, Modelling Legal Contracts as Processes, Department of Computing, King's College London [______], contracts are regarded as a process and are analyzed in terms of the obligations that are active at various points during the life span of the contract. To do this, Daskalopulu requires an informal notation that summarizes the states of an agreement as it evolves over time, which enables one to determine the status of an agreement given an event or sequence of events that concern the performance of actions by the agents involved in the underlying agreement. This proposed solution for document and legal contract management, while theoretically elegant, is extremely problematic for practical implementation. The proposed informal notation is proprietary and untested and bears no relation to the underlying meaning of the language in the subject agreement. Therefore, what is needed is a system and method that overcomes these significant problems found in the conventional systems as described above.

### SUMMARY

Accordingly, described herein are systems and methods for multiparty document generation and management that address the problems found in the conventional systems. The system allows a plurality of users to collaboratively generate a document model. During the document model generation process, the system is configured to provide suggestions to the plurality of users regarding the structure of the document model. A document model comprises a plurality of elements and for each element, the system obtains standard language from a data storage area that houses a plurality of predetermined clauses. The standard language obtained for each element corresponds to the purpose of the element in the document model. When standard language has been obtained for each of the elements, the system generates a complete multiparty document and validates the complete multiparty document. The validation process might require updates to the document model, and upon completion of the validation process, the document model including such updates and the complete multiparty document are stored in a data storage area. Once a document model has been created, the document model can be traversed and analyzed in response to a query to provide a forecast that includes an expected result of an application of the multiparty document to the subject matter of the query.

In an alternative embodiment, the document model is generated from a legacy document (e.g., an existing document). In such an embodiment, the legacy document is ingested (e.g., scanned and converted into characters using optical character recognition) and then parsed to identify a plurality of document elements in the legacy document. The document elements are then analyzed to determine corresponding standard language for each document element and the document model is built based on the identified document elements. The document model can be presented through a user interface to one or more users in a revision process until the document model is complete. The document model is then stored in a data storage area. The system may also optionally generate a new complete text document using the standard language corresponding to each of the document elements in the document model and then validate the complete text document and update the document model in accordance with the validation if necessary prior to storing the document model.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for managing multiparty documents according to an embodiment of the invention;

FIG. 2 is a block diagram illustrating an example multiparty document server according to an embodiment of the invention;

FIG. 3 is a block diagram illustrating an example model module according to an embodiment of the invention;

FIG. 4 is a block diagram illustrating an example governance module according to an embodiment of the invention;

FIG. 5 is a flow diagram illustrating an example process for building a multiparty document model according to an embodiment of the invention;

FIG. 6 is a flow diagram illustrating an alternative example process for building a multiparty document model according to an embodiment of the invention;

FIG. 7 is a flow diagram illustrating an example process for searching a multiparty document model according to an embodiment of the invention;

FIG. 8 is a flow diagram illustrating an example process for implementing a multiparty document according to an embodiment of the invention; and

FIG. 9 is a block diagram illustrating an example wired or wireless processor enabled device that may be used in connection with various embodiments described herein.

### DETAILED DESCRIPTION

Certain embodiments disclosed herein provide for systems and methods for multiparty document generation and management. For example, one method disclosed herein allows for the system to present a user interface to a plurality of users who collaborate to build a document model including a plurality of elements. The system then obtains standard language corresponding to each element and generates a multiparty document based on the document model and the standard language. The document model is thereafter stored and available to be analyzed by the system in response to queries regarding the expected results of the application of the multiparty document. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

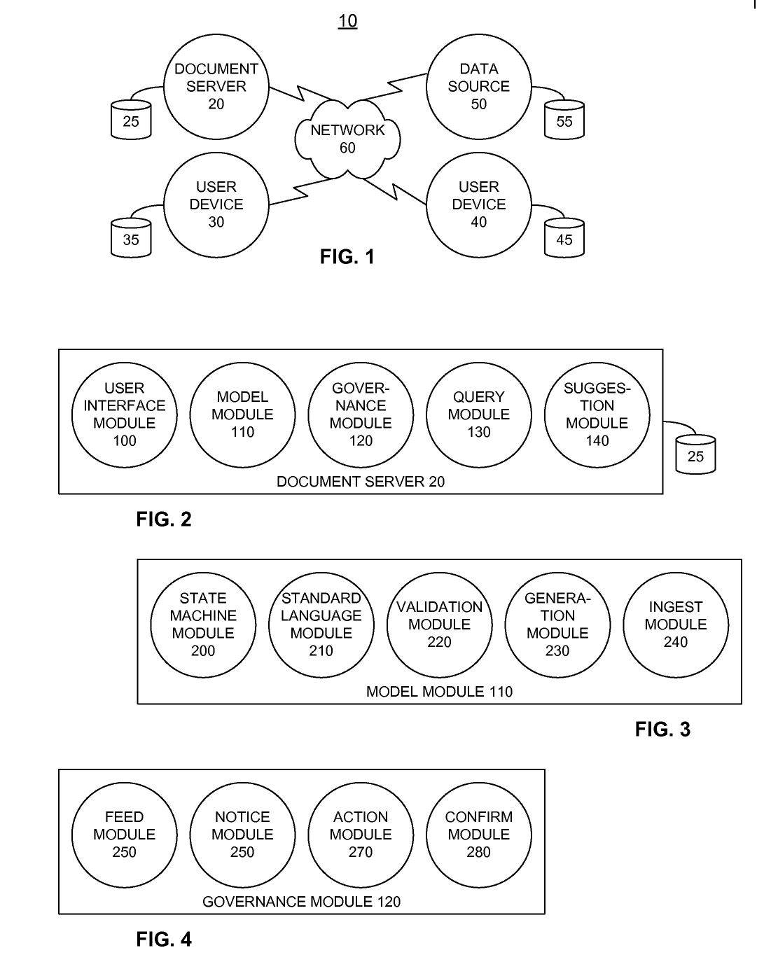

FIG. 1 is a network diagram illustrating an example system 10 for managing multiparty documents according to an embodiment of the invention. In the illustrated embodiment, the system 10 comprises one or more document servers 20, one or more user devices 30 and 40, and one or more data sources 50. Each of these devices is configured with a data storage area (25, 35, 45 and 55) and are communicatively coupled with one another via a data communication network 60. As will be understood by those skilled in the art, the network 60 may be any single implementation or combination of a wired or wireless network that is public or private, packet switched or circuit switched, and runs proprietary or open communication standards and applications.

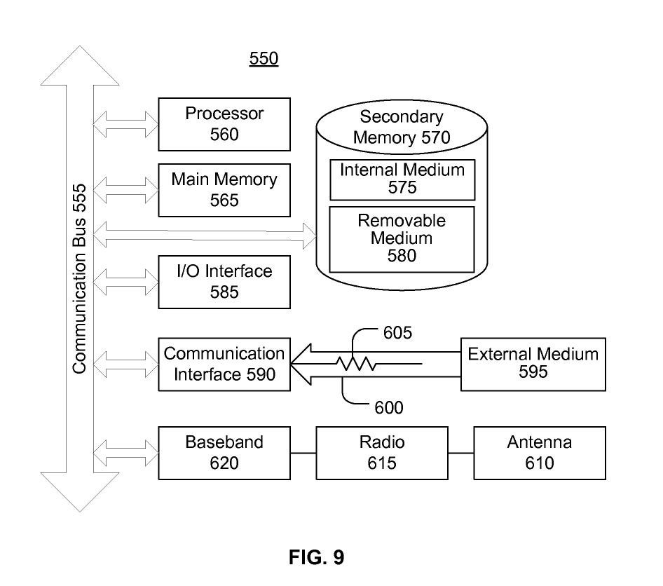

The document server 20 can be any sort of processor implemented computing device that is configured with a data storage area 25 that stores document models, corresponding complete documents and related information and executable modules. An example processor implemented computing device is described later with respect to FIG. 9. The document server 20 interacts with user devices to build document models and generate complete documents. The document server 20 also interacts with user devices 30 and 40 to respond to queries related to a complete document. The document server also interacts with the data source 50 to obtain information related to the document models and complete documents stored in the data storage area 25.

The user devices 30 and 40 can be any sort of processor implemented computing devices that are configured with respective data storage areas 35 and 45 that store document models, corresponding complete documents and related information and executable modules. The user devices 30 and 40 interact with the document server 20 to facilitate the building of document models and generation of complete documents and also facility other user interactions with the document server 20.

The data source 50 can be any sort of processor implemented computing device that is configured with a data storage area 55 that stores information related to document models and complete documents stored in the data storage area 25. The document server 50 may proactively provide such information to the document server 20 or it may provide such information to the document server 20 in response to a request from the document server 20.

FIG. 2 is a block diagram illustrating an example multiparty document server 20 according to an embodiment of the invention. In one embodiment, the server 20 can be any sort of processor implemented device such as the device later described with respect to FIG. 9. In the illustrated embodiment, the server 20 is configured with a data storage area for storing information, data and programmed modules. As will be understood by the skilled person, a module can alternatively be implemented using hardware and can also be a combination of programmed and hardware elements. The types of information, documents and document models that can be stored in the data storage area vary widely with the intended scope of the present invention and include but are not limited to: legal documents, business documents, legislative documents and any other type of document capable of being modeled using the present invention such as wills, trusts, contracts, employment agreements, insurance policies, legislation, statutes and technical manuals, just to name a few.

In the illustrated embodiment, the document server 20 comprises a user interface module 100, a model module 110, a governance module 120, a query module 130 and a suggestion module 140. The user interface module 100 is configured to present information on a display and receive input from a plurality of users. The user interface module 100 is also configured to cooperate with the various other modules of the server 20 to present information on a display and receive input from users related to the particular purpose of such other modules. For example, the user interface module 100 can present a query screen on a display, receive query input from a user, provide the query input to the query module 130 for processing, receive query results from the query module 130 and present query results on a display.

The model module 110 is configured to receive input and build or update a document model. The input may be received from one or more users or the input may be received from another module. A document model comprises a plurality of inter-related document elements. The document elements are interrelated by states and events such that when the document model is in a first state, a first set of direct, indirect or unrelated relationships between the document elements exists. Additionally, when a certain event or combination of events may happen, the document model may transition into a second state, causing a second set of direct, indirect or unrelated relationships between the document elements to exist. Accordingly, the model module 110 is configured to receive input and information and build or update a document module that comprises a plurality of document elements that are interrelated by a plurality of states and events.

The governance module 120 is configured to manage over time the implementation of a document model. The governance module 120 may receive input from one or more users or the input may be received from another module and the governance module 120 is configured to respond to such input, for example by sending a notice to a party associated with a document model or to take some other predetermined action in accordance with such input.

The query module 130 is configured to receive input and generate responses in accordance with the input. The input may be received from one or more users or the input may be received from another module. For example, the governance module 120 may provide input to the query module 130 or the governance module 120 may receive the input from one or more users, e.g., indirectly via the user interface module 100. In one embodiment, the query module is configured to receive an input, identify one or more document models that are related to the input, parse the input to determine one or more queries, traverse the one or more document models to generate a response to the one or more queries and then provide one or more response to the input. The query module 130 may also combine the one or more responses to the one or more queries into a single response that is then provided in response to the input.

Importantly, the input to the query module 130 may or may not be in the form of a traditional query. For example, the input may be in the form of a news report regarding a corporate merger. Because some document models may be related to the corporations that are the subject of the merger or may be related to investments targeting those corporations, such input can be used by the query module 130 to traverse the document model and identify any states and events that are related to those corporations. The query module 130 may then generate a response that identifies any changes in state that may be triggered by the merger of the subject corporations. As will be understood, this is merely one example of the wide range of possible inputs and responses that can be handled by the query module 130.

The suggestion module 140 is configured to improve the structure of a document model. The suggestion module 140 is configured to do so by cooperating with the model module 110 during building of a document model to provide feedback regarding the proposed elements of the document module that is being built. For example, when two parties (e.g., husband and wife) are building a document model for a conventional family trust document, the suggestion module 140 is configured to analyze the desired document elements for the document model as proposed by the parties and based on certain statistical data and document model heuristics, provide suggestions regarding the states and events that interrelate the desired document elements. Advantageously, this allows the suggestion module 140 to alert the parties to any inconsistent document elements or inconsistent states and events that have been proposed by the parties. The suggestion module 140 is also configured to cooperate with other modules, for example the user interface module 100, in order to present its suggestions on a display or to provide its suggestions to another module for further processing.

FIG. 3 is a block diagram illustrating an example model module 110 according to an embodiment of the invention. In the illustrated embodiment, the model module 110 comprises a state machine module 200, a standard language module 210, a validation module 220, a document generation module 230 and an ingest module 240. The state machine module 200 is configured to generate a state machine in accordance with received input that is related to a plurality of document elements and events. For example, the state machine module 220 preferably identifies a plurality of states and related events that provide transitions between a first state and a second state. The state machine module 200 is configured to cooperate with other modules during the building of a document model. For example, the state machine module 200 is configured to cooperate with the user interface module 100 when one or more parties are dynamically building a document module and the state machine module 200 is configured to cooperate with the ingest module 240 when a legacy document is being analyzed to build a document model.

The standard language module 210 is configured to identify a predetermined clause to be associated with a document element. For example, in one embodiment a document model may include an element that one or more parties to the document desire to appoint a guardian upon a certain event. The standard language module 210 is advantageously configured to analyze a data storage area of predetermined clauses to identify appropriate predetermined language to carry out the desired appointment upon the happening of the certain event. Importantly, the standard language module 210 is configured to identify the appropriate predetermined language based upon a set of factors including the desired action and the certain event and also including for example the state law to which the document module is subject. Accordingly, if certain specific language is required to appoint a guardian in California and that language differs from the specific language that is required to appoint a guardian in New York, the standard language module 210 identifies the appropriate predetermined language to carry out the desired appointment based upon the specific California or New York requirements.

The standard language module 210 is also configured to analyze language in a legacy document and identify equivalent predetermined language for the language in the existing document. In one embodiment, the standard language module 210 is configured to cooperate with the ingest module 240 when a legacy document is being analyzed to build a document model so that standard language for the elements in the document model can be identified. The standard language module 210 is also configured to cooperate with the user interface module 100 when one or more parties are dynamically building a document module.

The validation module 220 is configured to validate a document model by confirming that the various document elements comprising states and events are internally consistent. The validation module 220 is also configured to validate a document model by presenting the document model on a display and receiving an input from one or more parties that validate the document model in its presented form. Advantageously, the validation module 220 is configured to cooperate with the suggestion module 140 and provide the suggestion module 140 with information about inconsistencies in the various states and events of the document elements in the document model.

In one embodiment, the validation module 220 is also configured to cooperate with the document generation module 230 to validate a full text document that is generated by the document generation module based on a document model.

The document generation module 230 is configured to generate a full text document based on a complete document model. In one embodiment, the document generation module 230 is configured to cooperate with the standard language module 210 and the state machine module 200 to generate a complete text document that reflects all of the various document elements and their respective states and events that comprise the complete document model. The document generation module 230 is also configured to cooperate with the validation module 220 and the user interface module 100 to validate a full text document after such a full text document is generated. For example, the document generation module 230 may present the full text document on a display in cooperation with the user interface module 100 to allow a user to review the full text document and the document generation module 230 may receive feedback from a user in cooperation with the user interface module 100 that validates the full text document. The document generation module 230 may also receive feedback from a user in cooperation with the user interface module 100 that causes the document generation model to revise the full text document prior to validation.

In one embodiment, the document generation module 230 may receive feedback from a user in cooperation with the user interface module 100 that results in revisions to the underlying document model by the state machine module 200 for example by revising one or more document elements and its related states and events. The document generation module 230 may also receive feedback from a user in cooperation with the user interface module 100 that results in revisions to the underlying document model by the standard language module 210 for example by revising the predetermined language clauses.

The ingest module 240 is configured to receive a legacy document and parse the legacy document in cooperation with the state machine module 200 and validation module 220 to build a document model for the legacy document. The ingest module 240 is also configured to cooperate with the standard language module 210 and the generation module 230 to generate a full text document that is the equivalent of the legacy document but instead uses the predetermined language clauses identified by the standard language model.

FIG. 4 is a block diagram illustrating an example governance module 120 according to an embodiment of the invention. In the illustrated embodiment, the governance module 120 comprises a feed module 250, a notice module 250, an action module 270 and a confirm module 280. The feed module 250 is configured to monitor and interrogate one or more internal or external data sources for information that is related to one or more document models. For example, the feed module 250 may be configured to monitor news events related to corporate mergers to identify when two corporations have been merged. The feed module 250 may also be configured to provide the merger information to the query module 130 in order to identify one or more document models that are related to the merger of the subject companies. For example, a living trust document model may require that the trustee not invest more than 10% of the funds in the trust in any one company. After the merger of two companies, the invested funds for the example living trust document model may exceed the maximum value of 10% invested in the newly merged company. The feed module 250 advantageously monitors internal or external data sources for information and provides such information to other modules to facilitate timely and appropriate governance of a document model.

The notice module 250 is configured to provide notice related to certain states or events that are related to a document model. Such notice may be provided to one or more parties to the document model or notice may be provided to a predetermined third party. For example, the trustee of a living trust may receive notice from the notice module 250 when the invested funds for the living trust exceed 10% in any one company, as described in the example above. The notice module 250 is also configured to provide notice to another module as necessary or desired. For example, the notice module 250 may provide notice to the action module 270 when a particular state is reached in accordance with a document model. Keeping with the example above, if the invested funds of a living trust exceed 10% in an merged corporate entity, the notice module 250 may provide a notice to the action module 270 to allow the action module 270 to take an action such as divesting a certain percentage ownership in the merged entity. Similarly, the notice module 250 may provide a notice to the confirm module 280 to prompt the confirm module 280 to analyze the investment holdings of the living trust to confirm that a certain percentage ownership of a particular stock had in fact been divested as of a particular date.

The notice module 270 is also configured to cooperate with the feed module to analyze a variety of information to ensure compliance with one or more document models that are actively being monitored by the system.

The action module 270 is configured to take an action. Advantageously, any of a variety of programmed actions may be carried out by the action module 270. As described above, the action module 270 may be integrated with an equities transaction engine and consequently have the ability to buy and sell stocks. The action module 270 may also be integrated with one or more financial institutions and various accounts with such financial institutions that give the action module 270 the ability to transfer funds, make electronic payments and the like.

The confirm module 280 is configured to confirm a variety of items related to the monitoring and governance of a document model, for example whether or not a check has been mailed to a trust beneficiary and whether or not tuition, rent or a mortgage has been paid. Advantageously, the confirm module 280 is configured to cooperate with the action module 270 and the notice module 250 to confirm the status of any of a variety of items related to the governance of one or more document models.

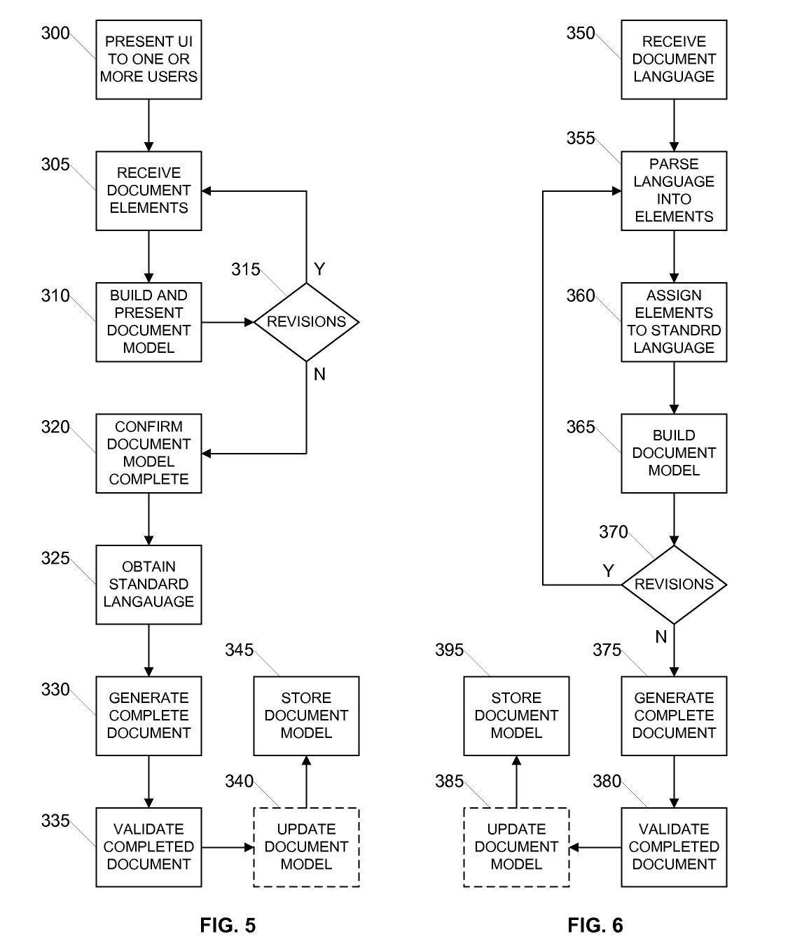

FIG. 5 is a flow diagram illustrating an example process for building a multiparty document model according to an embodiment of the invention. In one embodiment, the illustrated process can be carried out by a system such as previously described with respect to FIGS. 1-4. Initially, in step 300 the system presents a user interface to one or more users. For example, the system causes the user interface to be presented on one or more display devices that can be viewed by one or more users. As a practical matter, each user is typically viewing a separate display device. The separate display devices can be geographically remote or close in proximity such as in different cities, different cubicles in the same office building, or at different stations at the same table. Advantageously, the user interface allows the system to receive input and in step 305 the system receives document elements as input from the one or more users. Document elements can take a variety of forms and for example may include a concept such as establishing a guardian. A document element can be related to a particular state and can also be related to one or more events that cause the state to come into effect and one or more events that cause the state to cease to be in effect.

Once one or more document elements have been received, in step 310 the system builds and presents a document model. If revisions to the document model need to be made, as determined in step 315, the system returns to step 305 where additional or revised document elements are received. The system iteratively proceeds through receiving document elements and revisions to document elements and building and presenting a document model. During this iterative process, the system advantageously can make suggestions as to how the document model can be improved for internal consistency, efficiency, or otherwise.

When no additional revisions are identified, as determined in step 315, the system confirms that the document model is complete as shown in step 320. In one embodiment, the system may confirm that the document model is complete by analyzing the document model with a validation module that confirms that the document model is internally consistent. The system may also generate a graphical representation of the document model and present the graphical representation on a display and receive an input from a user that the graphical representation of the document model is complete.

After the document model is confirmed to be complete, in step 325 standard language (i.e., predetermined language clauses) that is associated with each document element is obtained. In one embodiment, a separate data store of predetermined language clauses is consulted to obtain the standard language for each document element. Once the standard language has been obtained, a complete text document is generated in step 330 and the complete text document is then validated in step 335. Validation can include computerized analysis of the semantics and grammar of the complete text document and may also include a process that allows the complete text document to be reviewed by a subject matter expert online or offline. If necessary after validating the complete text document, in optional step 340 the document model can be updated and then in step 345 the document model is stored. Additionally, in step 345 or after step 335, the completed text document can also be stored.

FIG. 6 is a flow diagram illustrating an alternative example process for building a multiparty document model according to an embodiment of the invention. In one embodiment, the illustrated process can be carried out by a system such as previously described with respect to FIGS. 1-4. Initially, in step 350 the system receives the language of a legacy document. In one embodiment, the legacy document language may be received after a digital scan of a paper of the legacy document and optical character recognition of the digitally scanned text of the legacy document. The legacy document language may also be received from a digital copy of the legacy document.

Once the digital text of the legacy document language is received, the system next parses the language into a plurality of document elements, as shown in step 355. In one embodiment, the parsing of the language separates the text of the legacy document into atomic segments and then identifies individual atomic segments and combinations of atomic segments that correspond to a single document element. After the legacy document text has been parsed into document elements, in step 360 standard language is assigned to each document element. The standard language can be obtained from a data storage area comprising a plurality of predetermined clauses.

Once the standard language has been assigned to the document elements, the system builds the document model as shown in step 365. In one embodiment, the document model can be built prior to assigning standard language to each element. When the document model is built, the plurality of document elements are examined to determine a plurality of states and events that are associated with the plurality of document elements. The plurality of states and events are then arranged and related together into the document model. During the building of the document model, the model may go through a validation process or the user interface may allow one or more parties to review and revise the document model and if revisions are required, as determined in step 370, the process may loop back to step 355 to further parse the legacy document text into document elements and so forth. In come instances, no further parsing (step 355) or assigning of standard language (step 360) will be needed so the revision process may only involve identifying and arranging the plurality of states and events that are included in the document model.

When no further revisions are required, as determined in step 370, the system next generates a complete text document from the document model. Advantageously, the complete text document is the equivalent of the original legacy document but it uses the more desirable standard language found in its predetermined language clauses. After the complete text document is generated, the system validates the complete text document in step 375. As previously described, validation can include computerized analysis of the semantics and grammar of the complete text document and may also include a process that allows the complete text document to be reviewed by a subject matter expert online or offline. If necessary after validating the complete text document, in optional step 385 the document model can be updated and then in step 395 the document model is stored. Additionally, at any time after step 380, the complete text document can also be stored.

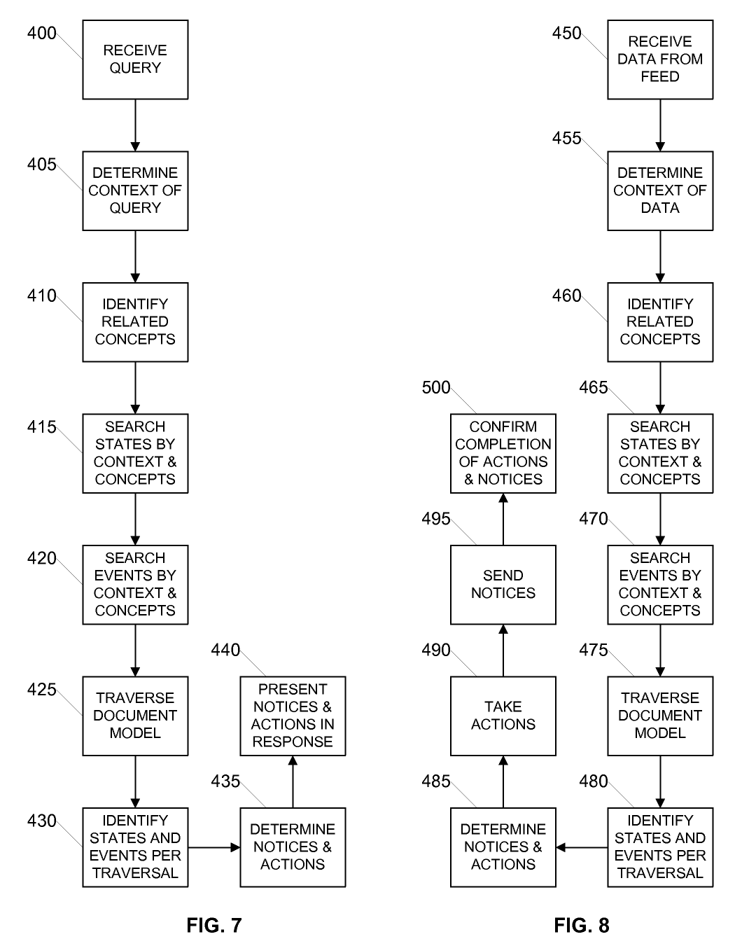

FIG. 7 is a flow diagram illustrating an example process for searching a multiparty document model according to an embodiment of the invention. In one embodiment, the illustrated process can be carried out by a system such as previously described with respect to FIGS. 1-4. Initially, in step 400 the system receives an input and determines to process the input as a query. Advantageously, the received input does not have to conform to a particular query language or be in the form of a query, instead, the input can be a natural language input or data feed from a data source that is parsed by the system and processed as a query. Once the system has determined to process the input as a query, in step 405 the system determines the context of the query. In one embodiment, the context can be determined using at least in part a semantic and grammatical analysis of the input.

Next, in step 410 the system identifies concepts that are related to the context of the query and then in steps 415 and 420 the system searches the various states and events in the document model for matches or near matches to the context of the query and the identified concepts that are related to the context of the query. Next, in step 425, the system traverses the document model, for example by logically stepping through the various possible states in the document model and in step 430 the states and events that are related to the context of the query or the related concepts are identified. In step 435, any notices and actions that are associated with the identified context and related concepts and the identified states and events are determined. Next, the determined notices and actions are presented as shown in step 440. Presentation of the determined notices and actions can be accomplished by presenting information on a display monitor or by digital delivery of the information to a digital inbox or by digital delivery of the information to a data storage area or a programmed module for further processing. In one embodiment a programmed module may consult a predetermine data storage area and thereby receive the determined notices and actions for further processing.

FIG. 8 is a flow diagram illustrating an example process for implementing a multiparty document according to an embodiment of the invention. In one embodiment, the illustrated process can be carried out by a system such as previously described with respect to FIGS. 1-4. Initially, in step 450 the system receives data from a data source. In one embodiment, a data source is a digital feed of information that is proactively provided by a third party data source. Alternatively, a data source can be a digital feed of information from a third party data source that is responsive to a query from the system. Alternative data sources can also be employed as will be understood by those skilled in the art.

Next, in step 455 the received data is examined and analyzed to determine a context for the data. Because the received data may include a variety of formats (e.g., a bank statement, a news article or a report card—just to name a few), the system advantageously includes a powerful data processing capability to analyze, parse and determine the context of digital data. Upon determining a context for the received digital data, in step 460 the system identifies concepts that are related to the context of the data. For example, if the received data referred to a “pet” then the related concepts might include fish, dogs, cats, rabbits, hamsters, gerbils, and any of a variety of other types of conventional and unconventional pets.

Next, in steps 465 and 470 the system searches the various states and events in the document model for matches or near matches to the context of the query and the identified concepts that are related to the context of the query. Next, in step 475, the system traverses the document model, for example by logically stepping through the various possible states in the document model and in step 480 the states and events that are related to the context of the query or the related concepts are identified. In step 485, any notices and actions that are associated with the identified context and related concepts and the identified states and events are determined.

Once the notices and actions have been determined, in step 490 all or a subset of the actions are taken. Examples of actions that can be taken include sending a check to a trust beneficiary, making a payment (e.g., a mortgage payment or a tuition payment), transferring funds between accounts or between financial institutions, divesting a portfolio of certain equity interests, purchasing stocks, and the like. A variety of alternative actions can also be taken as will be understood by those skilled in the art after reading the present description. In addition to taking actions (and perhaps before, after, or in parallel), in step 495 the system sends the notices associated with the notices that were previously determined in set 485. Finally, in step 500 the system confirms the completion of the various actions that were taken and the various notices that were sent.

FIG. 9 is a block diagram illustrating an example wired or wireless system 550 that may be used in connection with various embodiments described herein. For example the system 550 may be used as or in conjunction with a document server, user device or data source as previously described with respect to FIGS. 1-2. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A technical system for generating a multiparty document, the system comprising:
a non-transitory computer readable medium configured to store executable programmed modules;
a processor communicatively coupled with the non-transitory computer readable medium configured to execute programmed modules stored therein;
a user interface module stored in the non-transitory computer readable medium and configured to be executed by the processor, the user interface module configured to present a document model to a plurality of users and receive document model input from a plurality of users, wherein at least one user is a party to the multiparty document;
a model module stored in the non-transitory computer readable medium and configured to be executed by the processor, the model module configured to build a multiparty document model and store the document model in said computer readable medium;
a query module stored in the non-transitory computer readable medium and configured to be executed by the processor, the query module configured to receive an input from at least one of the plurality of users, analyze the multiparty document model in accordance with said input, and provide a forecast in response to said input, wherein the forecast is a an expected result based on the analysis; and
a suggestion module stored in the non-transitory computer readable medium and configured to be executed by the processor, the suggestion module configured to generate suggestions based on the analysis of the query module, said suggestions related to the structure of the multiparty document model.

2. The system of claim 1, further comprising a governance module stored in the non-transitory computer readable medium and configured to be executed by the processor, the governance module configured to monitor state changes associated with a multiparty document.

3. The system of claim 2, wherein the governance module is further configured to monitor the occurrence of events associated with a multiparty document.

4. The system of claim 3, wherein the governance module is configured to determine notices to be sent and actions to be taken and wherein the governance module is further configured to confirm that determined notices have been sent and determined actions have been taken.

5. The system of claim 3, wherein the governance module is further configured to receive data from a data source and analyze said received data to determine changes of state associated with a multiparty document or the occurrence of events associated with a multiparty document.

6. The system of claim 1, wherein the model module further comprises:
a state machine module stored in the non-transitory computer readable medium and configured to be executed by the processor, the state machine module configured to identify one or more states and one or more events associated with each document element of a multiparty document;
a standard language module stored in the non-transitory computer readable medium and configured to be executed by the processor, the standard language module configured to identify a predetermined clause and associate the identified predetermined clause with a document element; and
a validation module stored in the non-transitory computer readable medium and configured to be executed by the processor, the validation module configured to validate a document model comprising a plurality of document elements, wherein each document element is associated with one or more states and one or more events.

7. The system of claim 6, wherein the model module further comprises:
a document generation module stored in the non-transitory computer readable medium and configured to be executed by the processor, the document generation module configured to generate complete text document comprising a plurality of predetermined clauses.

8. The system of claim 7, wherein the model module further comprises:
an ingest module stored in the non-transitory computer readable medium and configured to be executed by the processor, the ingest module configured to receive text associated with a legacy document and build a document model for the legacy document in cooperation with the state machine module, the standard language module and the validation module.

9. A computer implemented method for generating a multiparty document, where one or more processors are programmed to perform steps comprising:
receiving a plurality of inputs from at least one user to a multiparty document;
associating at least a portion of each of said plurality of inputs with a multiparty document element;
building a document model of the multiparty document in accordance with said multiparty document elements;
presenting said document model to the at least one user to the multiparty document;
receiving confirmation that the document model is complete;
identifying a plurality of standard language portions, wherein each identified standard language portion is associated with at least one of said multi-document model elements;
compiling the plurality of standard language portions to generate the multiparty document;
validating the generated multiparty document; and
storing the multiparty document in a non-transitory computer readable medium.

10. The method of claim 9, wherein building a document model of the multiparty document in accordance with said multiparty document elements comprises associating at least one state and at least one event with each document element and logically traversing a plurality of states and events to verify each document element in the document model.

11. A computer implemented method for providing information related to a multiparty document, where one or more processors are programmed to perform steps comprising:
receiving a query, said query identifying a multiparty document represented by a document model having a plurality of states interconnected by a plurality of events;
determining a context for said query;
identifying one or more concepts related to said context for the query;
searching the plurality of states in the document model of the multiparty document for matches in accordance with said query context and the related concepts;
searching the plurality of events in the document model of the multiparty document for matches in accordance with said query context and the related concepts;
traversing the document model of the multiparty document to identify a set of states and events encountered based on said query context and the related concepts;
determining one or more notices and one or more actions in accordance with the identified set of states and events; and
presenting the determined one or more notices and one or more actions in response to said query.

12. The method of claim 11, wherein presenting comprises presenting the determined one or more notices and one or more actions on a display device.

13. The method of claim 11, wherein the query is received from a data source and wherein presenting comprises storing the determined one or more notices and one or more actions in a data storage area.

14. The method of claim 11, wherein the query is received from a user and the determined one or more notices and one or more actions are presented to the user in response to said query.

15. A computer implemented method for implementing a multiparty document, where one or more processors are programmed to perform steps comprising:
receiving data from a data source;
identifying a multiparty document represented by a document model having a plurality of states interconnected by a plurality of events;
determining a context for said data from the data source;
identifying one or more concepts that are related to the context for said data from the data source;
traversing the document model of the multiparty document to identify a set of states and events based on said query context and said related concepts;
determining one or more actions in accordance with the identified set of states and events;
taking at least one action to achieve a predetermined result in accordance with at least one of said one or more actions; and
confirming completion of said at least one action.

16. The method of claim 15 further comprising searching the plurality of states in the document model of the multiparty document for matches in accordance with said query context and the related concepts and searching the plurality of events in the document model of the multiparty document for matches in accordance with said query context and the related concepts and wherein the determining step comprises determining one or more actions in accordance with said matches.

17. The method of claim 15 wherein said one or more actions comprise one of selling a stock, transferring funds between bank accounts and paying a trust beneficiary.

18. The method of claim 15, further comprising:
determining one or more notices in accordance with the identified set of states and events;
sending a notice to a designated recipient in accordance with each of said one or more notices; and
confirming receipt of each of said sent notices.
